(19) United States
(12) Patent Application Publication
(10) Pub. No.: US 2015/0259206 A1
(43) Pub. Date: Sep. 17, 2015

(54) PROCESS FOR PRODUCING PURE TRISILYLAMINE

(71) Applicants: Carl-Friedrich HOPPE, Gruendau (DE); Christian Goetz, Seligenstadt (DE); Goswin Uehlenbruck, Oberursel (DE)

(72) Inventors: Carl-Friedrich HOPPE, Gruendau (DE); Christian Goetz, Seligenstadt (DE); Goswin Uehlenbruck, Oberursel (DE)

(73) Assignee: Evonik Industries AG, Essen (DE)

(21) Appl. No.: 14/658,011

(22) Filed: Mar. 13, 2015

(30) Foreign Application Priority Data
Mar. 14, 2014 (DE) 102014204785.4

(51) Int. Cl. C01B 21/087; B01J 19/18

(52) U.S. Cl. CPC C01B 21/087; B01J 19/18; B01J 2219/00051

(57) ABSTRACT

A process for producing trisilylamine in the liquid phase by charging monochlorosilane in the liquid state in a solvent at elevated temperature, and reacting the monochlorosilane with NH₃ in a stoichiometric excess is provided. Additionally provided is a production unit for carrying out the process.

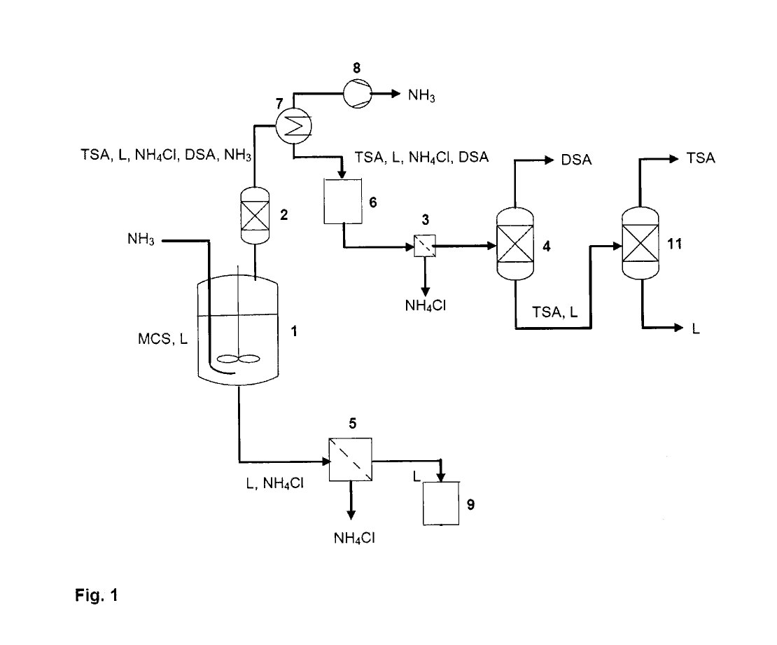

### CROSS REFERENCE TO RELATED APPLICATIONS

This application claims priority to German Application No. 102014204785.4, filed Mar. 14, 2014, the disclosure of which is incorporated herein by reference in its entirety.

### BACKGROUND OF THE INVENTION

The invention relates to a process for producing trisilylamine in the liquid phase by charging monochlorosilane in the liquid state in a solvent at elevated temperature, and reacting the monochlorosilane at this temperature with NH₃ in a stoichiometric excess.

In the context of the invention, trisilylamine is abbreviated to TSA, disilylamine to DSA, monochlorosilane to MCS.

TSA is used for generating silicon nitride layers, as described, e.g. in U.S. Pat. No. 4,200,666 and JP 1986 96741. TSA is used, in particular, in chip production as layer precursor for silicon nitride or silicon oxynitride layers, e.g. in US 2011/0136347. A specific process for using TSA is disclosed by WO 2004/030071, in which it is made clear that the safe, malfunction-free production of TSA in constant high quality is particularly important for use in chip production.

The production of TSA proceeds in accordance with the following reaction equation:

3SiH₃Cl+4NH₃→3NH₄Cl+(SiH₃)₃N (1)

The reaction was described for the first time in 1921 by Stock and Somieski [1]. The reaction was carried out at that time in the gas phase.

Conventionally, two reaction mechanisms are described for the synthesis of TSA from ammonia and MCS.

Wannagat [2] described synthesis according the following three-step reaction.

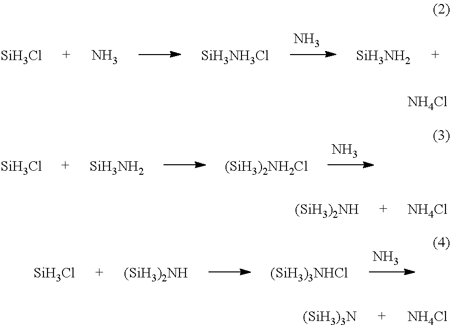

In this case MCS and ammonia react in the first equation to form an adduct which reacts to completion with a further molecule of ammonia to give monosilylamine and ammonium chloride (2). In the next equation (3), the monosilylamine reacts with a further molecule of MCS to form an adduct which reacts to completion with a further molecule of ammonia to form disilylamine and ammonium chloride. Then (4) the disilylamine reacts with a further molecule of MCS to form an adduct which reacts to completion with a further molecule of ammonia finally to form trisilylamine and ammonium chloride.

According to Wannagat and/or MacDiarmid [2, 3], the condensation reactions (6) and (7) are also to be taken into consideration with respect to the reaction mechanism.

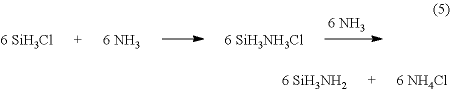

6SiH₃NH₂→3(SiH₃)₂NH+3NH₃ (6)

3(SiH₃)₂NH→2(SiH₃)₃N+NH₃ (7)

In this case, MCS and ammonia react in equation (5) to form an adduct which reacts to completion with a further molecule of ammonia to form monosilylamine and ammonium chloride.

According to equation (6), monosilylamine condenses or disproportionates with the formation of disilylamine and ammonia, and finally, (7) disilylamine condenses or disproportionates with the formation of trisilylamine and ammonia.

Not only the reaction mechanism according to equations (2), (3) and (4), but also according to equations (5), (6) and (7), is a three-stage mechanism with monosilylamine [12] and disilylamine (see [6], [7], [8] and [12] and the present description) as intermediates. Miller [6] describes an apparatus and a method for producing TSA, wherein MCS and ammonia flow in the gaseous state through a reactor. The gas mixture exiting from the reactor is condensed out in a downstream cold trap at −78° C. The gas mixture and/or the condensed liquid exiting from the reactor contain monosilane, MCS, DSA and TSA. After heating up the cold trap to 20° C., the liquid contains monosilane, MCS and TSA.

Ritter [7] describes the TSA synthesis in a liquid-phase process using anisole as solvent. MCS is charged in anisole and ammonia is added to this solution.

Aylett and Hakim [4] disclose a process in which, when it is carried out, DSA remains unchanged, after the gas phase is heated to 150° C. for 3 hours. In addition, they report that DSA in the liquid phase, after 72 hours at 0° C., is 80% converted to TSA according to reaction equation (8).

3(SiH₃)₂NH→2(SiH₃)₃N+NH₃ (8)

In addition, it is reported that DSA and excess ammonia do not react in the gas phase at room temperature, and at −130° C., in the course of 1 minute, all of the DSA decomposes with the formation of silane and small amounts of ammonia.

Wells and Schaeffer [5] describe the condensation of MCS and ammonia in a reaction cuvette and heating from −196° C. to room temperature. In this case, in addition to TSA, monosilane, ammonia, polysilazanes and ammonium chloride are formed.

Korolev [8] describes the synthesis of TSA in the liquid phase using toluene as solvent. MCS is charged in toluene and ammonia is added to the solution. The mixture is stirred for a period of about 1 to 48 hours at a temperature of about minus 100° C. to 0° C. It is left unclear whether this time specification relates only to the period during which ammonia is added, or whether it is meant thereby, possibly not exclusively, the time period during which stirring is performed after addition is completed. The exemplary embodiments make clear that after the reaction, the mixture is stirred at room temperature for 24 hours. It may be concluded therefrom that the necessary time period for carrying out the process is more than 24 hours.

Miller [6] and Ritter [7] state that ammonium halides, such as ammonium chloride, are catalysts in the presence of which TSA disproportionates into silane and other breakdown products. As a result, the yield of TSA falls.

In all of the exemplary embodiments of Ritter [7], with the exception of Examples 9 and 10, marked MCS excesses are employed. Operating with an MCS excess means that MCS passes into the workup by distillation and deposits of ammonium chloride occur there—as a consequence of the reaction of DSA with MCS, with the formation of ammonium chloride.

Example 9 shows an MCS deficiency of 26 mol %. If the TSA yield of 85% listed in Example 9 is based on ammonia, as in Examples 1-7 of Table 1, an impossible TSA yield based on MCS of 115% would result by calculation.

In Example 10 of Ritter [7], the addition of twice the stoichiometric amount of ammonia is described. The results show that no TSA formed and only monosilane and ammonia were detected.

The TSA yields based on MCS which are disclosed in Ritter [7] in exemplary embodiments 1-8 and 11-13, are, except for the TSA yield in the 11th Example (68%), between 14% and 58%. The reason for this is, inter alia, the high MCS excess compared with ammonia.

The stoichiometric MCS excess disclosed in Example 1 of Korolev [8] leads to the fact that MCS passes into the workup by distillation and, there, deposits of ammonium chloride occur as a result of the reaction of DSA with MCS.

The MCS-based TSA yields in the exemplary embodiments of Korolev are 57%, operated with a stoichiometric NH₃ deficiency (Example 1), 63% at the stoichiometric ratio NH₃:MCS (Example 2) and 34% with a stoichiometric NH₃ excess in Example 3. It is stated that a stoichiometric excess of ammonia leads to a low yield of TSA and the formation of “unwanted” by-products. Therefore, the stoichiometric molar ratio of MCS to ammonia is preferably 1:1 to 1.5:1. In addition, it is stated that excess MCS produces good yields and purities of TSA. Therefore, the stoichiometric molar ratio of MCS to ammonia particularly preferably is 1.1:1 to 1.5:1 (Section [0045]).

In the case of the mode of operation with excess NH₃, Example 3 in Korolev does not state that DSA is formed in addition to TSA. Furthermore, products which are formed by condensation reaction between ammonia and TSA are additionally observed.

Further, Korolev describes that TSA purified by distillation has a purity of approximately 97% mol/mol to approximately 100% mol/mol. The TSA has, according to the exemplary embodiments, purities of 91% mol/mol (Example 1), 92% mol/mol (Example 2) and 40% mol/mol (Example 3).

Ritter [7] provides no statements on the purity of the TSA obtained.

Hoppe [9, 10, 11], describes the synthesis of TSA in the liquid phase using an inert solvent, preferably toluene.

Hoppe [10] discloses a process for the coupled production of polysilazanes and trisilylamine, in which TSA and polysilazanes are prepared by reaction of monochlorosilane by addition of initially a stoichiometric amount of ammonia. TSA is subsequently separated off in gaseous form from the product mixture. Only after the separation is further ammonia added, so that in this step a stoichiometric excess of the total ammonia introduced relative to the amount of monochlorosilane initially charged results for the first time. Monochlorosilane is reacted incompletely as a result of the addition of the initially substoichiometric amount of ammonia to the reactor. Accordingly, in the subsequent isolation of gaseous TSA, monochlorosilane and small amounts of disilylamine formed also go into the TSA product solution. Disilylamine and monochlorosilane react with one another. This reaction proceeds slowly and is associated with the precipitation of further ammonium chloride. As a result, precipitation of ammonium chloride occurs in the TSA product solution taken off from the reactor or in the parts of the plant downstream of the reactor. Owing to the slow reaction, precipitation of ammonium chloride occurs again in the TSA product solution filtrate after the filtration. In particular, this reaction leads to ammonium chloride deposits in rectification columns employed for purifying the TSA.

Hoppe [11] describes a process for the coupled production of polysilazanes and trisilylamine from monochlorosilane and ammonia, in which the disadvantages and limitations cited in [10] are completely circumvented, in particular the subsequent formation of ammonium chloride by reaction of monochlorosilane with disilylamine in plant parts for purifying the TSA product stream outside the reactor is prevented.

For this purpose, ammonia is added directly and in one step in a superstoichiometric amount relative to monochlorosilane which is present in an inert solvent. As a result of the NH₃ being introduced in a superstoichiometric amount relative to monochlorosilane, monochlorosilane is completely reacted in the reactor. The reaction of monochlorosilane with additional disilylamine formed in small amounts to give solid ammonium chloride is thus prevented in downstream parts of the plant by the introduction of a superstoichiometric amount of NH₃ relative to monochlorosilane.

The product mixture containing TSA is subsequently separated off in gaseous form. The product mixture obtained is filtered and is then completely free from ammonium chloride. TSA is purified by rectification and obtained in high or very high purity. The rectification columns used do not contain any solid ammonium chloride after the rectification.

Even in view of the work described in the foregoing paragraphs, there remains a need for a commercial process which provides TSA in relatively high purities.

Thus an object of the present invention is to provide a process which synthesizes TSA as completely as possible and without formation of significant amounts of DSA. The object includes avoiding as far as possible the catalytic decomposition of TSA via ammonium chloride into silane and other breakdown products observed in presently known methods of TSA synthesis.

### SUMMARY OF THE INVENTION

This and other objects have been achieved by the present invention, the first embodiment of which includes a liquid phase process for producing trisilylamine (TSA), comprising:

charging to a reactor of a production unit comprising the reactor, a distillation unit, a vacuum unit and a heat exchanger, a liquid solution comprising a solvent and monochlorosilane (MCS);

stirring the solution in the reactor;

setting the solution temperature to 10° C. or above and maintaining that temperature through reaction;

introducing NH₃ into the reactor in a stoichiometric excess relative to the MCS to conduct a reaction between the NH₃ and MCS to obtain a product mixture comprising TSA, disilylamine (DSA), solvent, NH₄Cl and NH₃;

depressurizing the reactor and setting the pressure to from 0.5 bar a to 0.8 bar a;

heating the reactor to obtain a gaseous product mixture comprising TSA, disilylamine (DSA), solvent, NH₄Cl and NH₃ and a bottom liquid mixture comprising solvent and NH₄Cl;

conducting the gaseous product mixture through the distillation unit;

separating the NH₃ from the gaseous product mixture via the vacuum unit;

condensing the gaseous product mixture from which the NH₃ is separated in a heat exchanger;

collecting the condensed product mixture as a solid-liquid mixture comprising TSA, solvent, solid NH₄Cl, and DSA in a vessel;

filtering the solid-liquid mixture in a filter unit to separate the solid NH₄Cl from a filtrate liquid comprising TSA, DSA and solvent;

conducting the filtrate liquid from the filter unit into a batch rectification column or to a rectification system comprising a first rectification column and a second rectification column;

wherein when the filtrate liquid is conducted to a batch rectification column, DSA is first separated off overhead and then TSA is separated off overhead; and

when the filtrate liquid is conducted to the rectification system,

the DSA is separated off overhead from the first rectification column to obtain a bottom mixture of TSA and solvent;

the liquid mixture of TSA and solvent is conducted into a second rectification column and the TSA is separated off overhead from the solvent; and

recirculating the solvent; wherein

the solvent is inert with respect to MCS, ammonia (NH₃) and TSA, and a boiling point of the solvent is higher than the boiling point of TSA, and

wherein the bottom liquid mixture comprising solvent and NH₄Cl from the reactor is conducted through a filter unit in which solid NH₄Cl is separated off, and the solvent is collected in a vessel and optionally recirculated.

In a second embodiment, the present invention includes a production unit to conduct the liquid phase process according to the first embodiment, comprising:

a reactor, comprising:
a stirring unit;
a feed line for NH₃;
a feed line for a solution of at least MCS and a solvent;
an upper outlet which connects to a distillation unit; and
a bottom outlet; and downstream to the reactor;

a heat exchanger having an attached vacuum pump and a vessel;

a line from the vessel to a filter unit which comprises at least one solids outlet and

a further line for transfer of the filtrate which opens into either

a batch rectification column comprising an overhead outlet and a discharge facility from the bottom; or

a rectification system, comprising:

a first rectification column which is equipped with an overhead outlet, and a discharge facility from the bottom, which opens into

a second rectification column, which is equipped with an overhead outlet and a discharge facility from the bottom,

wherein the discharge facility from the bottom of the batch rectification column or the discharge facility from the bottom of the second rectification column is connected to a downstream filter unit which has at least one solids outlet and a further line for transfer of the filtrate which opens into a vessel.

The forgoing description is intended to provide a general introduction and summary of the present invention and is not intended to be limiting in its disclosure unless otherwise explicitly stated. The presently preferred embodiments, together with further advantages, will be best understood by reference to the following detailed description taken in conjunction with the accompanying drawings.

### BRIEF DESCRIPTION OF THE DRAWINGS

The FIGURE shows a schematic flow diagram of the reaction equipment set according to an embodiment of the present invention.

### DETAILED DESCRIPTION OF THE PREFERRED EMBODIMENTS

As used herein, the words “a” and “an” and the like carry the meaning of “one or more.” The phrases “selected from the group consisting of,” “chosen from,” and the like include mixtures of the specified materials. Terms such as “contain(s)” and the like are open terms meaning ‘including at least’ unless otherwise specifically noted. Where a numerical limit or range is stated, the endpoints are included. Also, all values and subranges within a numerical limit or range are specifically included as if explicitly written out.

The present invention provides a process during the performance of which the three-step reaction according to reaction equations (2), (3) and (4) or (5), (6) and (7) proceeds completely without significant amounts of DSA remaining in the product. This is equivalent to, after addition of ammonia to the reactor, the individual reaction steps being passed through rapidly, with formation of TSA, and the incomplete silylation of ammonia, and thus the progress of the reaction only up to the formation of DSA being avoided, except for small residual amounts of DSA.

The inventors believe that the concentration of the monochlorosilane and ammonia, the temperature, and also intensive mixing of the reactor have an important influence on the rapid and complete progress of the three-step TSA reaction.

As shown according to the FIGURE, the invention relates to a process for producing trisilylamine in the liquid phase, in that
(a) at least monochlorosilane (MCS) dissolved in a solvent (L) is charged in a reactor (1) in the liquid state, wherein
   the solvent is inert with respect to MCS, ammonia (NH₃) and TSA, and has a higher boiling point than TSA, the solution is stirred, and
   the temperature T of the solution is set to 10° C. or above, and
(b) the reaction is carried out in reactor (1), wherein NH₃ is introduced into the reactor (1) in a stoichiometric excess relative to MCS, wherein the temperature T is maintained, and then
(c) the reactor is depressurized, a pressure of from 0.5 bar a to 0.8 bar a is set, the reactor is heated, the product mixture (TSA, L, NH₄Cl, DSA, NH₃) is conducted in gaseous form overhead from the reactor (1) through a distillation unit (2), the NH₃ is separated off by means of a vacuum unit (8), the product mixture (TSA, L, NH₄Cl, DSA) is condensed in a heat exchanger (7) and the product mixture (TSA, L, NH₄Cl, DSA) is collected in a vessel (6), then
(d) the product mixture is filtered by means of filter unit (3), with solid ammonium chloride (NH₄Cl) being separated off from the product mixture and the filtrate is conducted from the filter unit (3) into the rectification column (4)
   in which DSA is separated off overhead from the mixture (TSA, L), and
   the mixture (TSA, L) is conducted into a rectification column (11), in which TSA is separated off overhead from the solvent (L), with the solvent being recirculated, or
   the filtrate is conducted from the filter unit (3) into a batch rectification column (4), from which DSA is first separated off overhead and then TSA is separated off overhead, with the solvent being recirculated,
   and
(e) the bottom product mixture (L, NH₄Cl) is conducted from the reactor (1) through a filter unit (5) in which solid ammonium chloride (NH₄Cl) is separated off, and the solvent (L) is obtained, which is collected in a vessel (9) and then
(f) 0 to 99% of this solvent is recirculated and non-recirculated solvent is replaced by solvent (L).

Thus according to the first embodiment the present invention provides a liquid phase process for producing trisilylamine (TSA), comprising:
charging to a reactor of a production unit comprising the reactor, a distillation unit, a vacuum unit and a heat exchanger, a liquid solution comprising a solvent and monochlorosilane (MCS);

stirring the solution in the reactor;

setting the solution temperature to 10° C. or above and maintaining that temperature;

introducing NH₃ into the reactor in a stoichiometric excess relative to the MCS to conduct a reaction between the NH₃ and MCS to obtain a product mixture comprising TSA, disilylamine (DSA), solvent, NH₄Cl and NH₃;

depressurizing the reactor and setting the pressure to from 0.5 bar a to 0.8 bar a;

heating the reactor to obtain a gaseous product mixture comprising TSA, disilylamine (DSA), solvent, NH₄Cl and NH₃ and a bottom liquid mixture comprising solvent and NH₄Cl;

conducting the gaseous product mixture through the distillation unit;

separating the NH₃ from the gaseous product mixture via the vacuum unit;

condensing the gaseous product mixture from which the NH₃ is separated in a heat exchanger;

collecting the condensed product mixture as a solid-liquid mixture comprising TSA, solvent, solid NH₄Cl, and DSA in a vessel;

filtering the solid-liquid mixture in a filter unit to separate the solid NH₄Cl from a filtrate liquid comprising TSA, DSA and solvent;

conducting the filtrate liquid from the filter unit into a batch rectification column or to a rectification system comprising a first rectification column and a second rectification column;

wherein when the filtrate liquid is conducted to a batch rectification column, DSA is first separated off overhead and then TSA is separated off overhead; and

when the filtrate liquid is conducted to the rectification system,

the DSA is separated off overhead from the first rectification column to obtain a bottom mixture of TSA and solvent;

the liquid mixture of TSA and solvent is conducted into a second rectification column and the TSA is separated off overhead from the solvent; and

recirculating the solvent; wherein

the solvent is inert with respect to MCS, ammonia (NH₃) and TSA, and a boiling point of the solvent is higher than the boiling point of TSA, and wherein the bottom liquid mixture comprising solvent and NH₄Cl from the reactor is conducted through a filter unit in which solid NH₄Cl is separated off, and the solvent is collected in a vessel and optionally recirculated.

The process has the advantage that a high reaction rate may be achieved owing to the choice of temperature above 0° Celsius, an intensive mixing of the reagents in the solution by means of stirring, and a high concentration of MCS by use of liquid MCS. The synthesis of TSA thus proceeds with a high formation rate, equivalent to rapid conversion of DSA to TSA. The process therefore achieves a high space-time yield.

A further advantage of the process according to the invention is that the TSA-solvent mixture may be distilled off from the reactor even a short time after completion of the reaction of b), because, at completion of b, the formation of TSA has proceeded virtually completely. Advantageously, at least a part of the amount of TSA that is distilled off is already present within an interval of at most 12, preferably 8, hours after completion of the addition of NH₃. As a result, the residence time of the TSA in the reactor may be kept short. The time after ammonia addition conventially employed need not be waited for TSA to be available and this may then be purified and isolated.

The inventors presume that the short residence time and contact time of the TSA in the reactor contributes to this advantageous effect, since as a result the unwanted disproportionation or reaction of the TSA with excess ammonia present in the reactor is reduced and thus the yield of TSA improves.

In addition, an advantage of the process is that, in d and e, the solvent (L) is obtained, the raw material may be added sparingly to the solvent L used in a, if the process is carried out batchwise more than once.

The TSA obtained after d may have a purity of at least 99.5% by weight. The stoichiometric excess used according to the invention of NH₃ relative to MCS has the advantage that MCS may be completely reacted in the reactor. This therefore prevents MCS from passing into the workup by distillation and there reacting with DSA, with formation of ammonium chloride. The ammonium chloride formed would lead to deposits that are disadvantageous in processing terms in the workup by distillation.

The process according to the present invention achieves a TSA yield, based on MCS, which may be high and/or of technical economic interest. Specifically, in the mode of operation according to the invention, a TSA yield which is improved compared to conventionally known processes, and a TSA purity of greater than 99.5% by weight may be achieved. Therefore, the process according to the invention likewise may have the advantage that the TSA generated is suitable for processing in the semiconductor industry.

The process according to the invention is explained in more detail below with regard to the individual operations and the FIGURE.

In reaction (b) it is necessary to monitor the temperature T. Since the reaction is exothermic, the enthalpy of reaction must be dissipated in a manner known to those skilled in the art, and the temperature maintained. Preferably, in reaction (b), an amount of ammonia may be used such that the stoichiometric NH₃ excess is from 0.5 to 20%, corresponding to the stoichiometric molar ratio MCS:NH₃ of 0.995 to 0.833. Preferably, an amount of ammonia may be used such that the stoichiometric NH₃ excess is from 0.5 to 10%, corresponding to the stoichiometric molar ratio MCS:NH₃ of 0.995 to 0.909. Particularly preferably, an amount of ammonia may be used such that the stoichiometric NH₃ excess is from 0.5 to 5%, corresponding to the stoichiometric molar ratio MCS:NH₃ of 0.995 to 0.953.

In (c), the reactor may be heated in a manner known to those skilled in the art in order to separate off the product mixture from the suspension in the reactor by distillation. At the start of distillation, unreacted excess NH₃ escapes, then DSA is taken off, subsequently TSA, subsequently solvent. The distillation may be continued until at the end only pure solvent is taken off. In this way, the secondary reaction of NH₃ with TSA may be suppressed, in that after a short period after completion of the NH₃ addition, the product mixture begins to distil off from the reactor. In this case the ammonia passes virtually completely into the off-gas via the vacuum pump. Very low residual amounts of ammonia remain present in the collected condensate, which contains TSA, DSA and solvent, which are removed together with the DSA in the subsequent rectification for separating off DSA overhead from the corresponding rectification column.

The solvent obtained in (d) may be completely recirculated. This applies not only to the batch-wise but also continuous mode of operation for the rectification column. It may be advantageous to recirculate 0 to 99% of the solvent recovered in (f) and to replace non-recirculated solvent by fresh solvent (L). Preferably, an inert solvent is used which does not form an azeotrope with TSA or DSA. The inert solvent should preferably be less volatile than TSA/ and/or have a boiling point at least 10 K higher than trisilylamine. Such preferred solvents may be selected from hydrocarbons, halohydrocarbons, halocarbons, ethers, polyethers and tertiary amines. Very particular preference may be given to using toluene as solvent (L). Such a selection has the advantage that the TSA is stable in toluene. In addition, ammonium chloride is sparingly soluble in toluene, which aids the removal of ammonium chloride by filtration.

A high concentration of reagents for achieving a high reaction rate may be achieved by using monochlorosilane in the liquid phase, diluted by a solvent (L). It may be advantageous to use the solvent (L), preferably toluene, in a volume excess over MCS in the process of the invention. Preferably, a volume ratio of the solvent to MCS of 30:1 to 1:1, preferably of 20:1 to 3:1 may be set. Particularly preferably, MCS may be diluted by the solvent in the volume ratio solvent: MCS of 10:1 to 3:1. However, at volume ratios in the range from 3:1 to 1:1, the advantages become smaller. A volume excess of solvent ensures dilution of MCS. This offers the advantage that the concentration of ammonium chloride formed during the reaction is decreased in the reaction solution and the reactor stirring and emptying may thus be facilitated. In addition, the catalytic decomposition of TSA described in Miller [6] and Ritter [7] by ammonium chloride may be decreased. However, excessively large volume excesses of solvent, e.g. above 30:1, may decrease the space-time yield in the reactor.

The effect of temperature, generally for an increase by 10 K, leading to a doubling in reaction rate is known. However, in Korolev [8], the reaction for production of TSA is carried out at a temperature of −100 to 0° C. This is because at higher temperatures a decreased yield of TSA in favour of the formation of polysilazanes is feared. It is assumed that at such temperatures the adducts shown in the middle in the reaction equations (2)-(5) are thermally unstable and they readily decompose with unwanted formation of polysilazanes, and so the yield of TSA falls.

In contrast, in the process of the present invention, it has surprisingly been found that at temperatures of 10° C. or above, polysilazanes are only formed in vanishingly low amounts.

Preferably, therefore, a temperature of 10° C. to 30° C. may be set in the reactor and maintained during the ammonia reaction, particularly preferably 10° C. to 20° C., and very particularly preferably a temperature of 10° C. is set and maintained.

For intensive thorough mixing of the reactor, a stirrer may be used in order to effect two advantages simultaneously. Firstly, ammonia metered into the reactor may be dispersed directly in order to avoid locally high concentrations of ammonia, in order that the ammonia introduced may be dispersed finely, and thereby suppress side reactions, forming polysilazanes. Secondly, by stirring, the ammonia chloride formed in the reactor can be suspended and held in suspension to avoid deposits. The choice of stirrer is known to those skilled in the art.

Having a temperature in the reactor of 10° C. or above, preferably of 10° C. to 30° C., particularly preferably 10° C. to 20° C., very particularly preferably 10° C., a volume ratio of the solvent to monochlorosilane from 30:1 to 1:1, preferably from 20:1 to 3:1, more preferably from 10:1 to 3:1, and also a stirrer-equipped stirred autoclave which disperses the metered ammonia directly, suspends the ammonium chloride formed and maintains it in suspension, a process is provided in which the TSA synthesis proceeds quasi in-situ with the metering of ammonia. Correspondingly, the metering of ammonia may be varied within a wide range and increased to achieve a space yield of interest for technical operations. At the same time, owing to the quasi in-situ formation of TSA, the post-reaction time required decreases, equivalent to a time period of necessary post-stirring of a maximum of 1 h resulting subsequent to the metering of ammonia. The post-stirring proceeds at the temperature set and maintained during reaction. According to Korolev [8], a markedly longer post-stirring of up to 48 h is required.

In the process according to the invention, in contrast, at a maximum of 1 h subsequent to the conclusion of the NH₃ metering, the reactor may be depressurized, the distillation pressure of 0.5 bar a to 0.8 bar a is set, the stirred autoclave is heated for the following distillation and subsequently TSA is distilled off from the reactor together with substantial fractions of toluene. The solution distilled off may then be fed to a rectification to produce pure TSA.

The heating may be carried out in order to distill TSA together with DSA, NH₃, with fractions of solvent and also small amounts of NH₄Cl out of the reactor. For this purpose, the product mixture (TSA, L, NH₄Cl, DSA, NH₃) may be conducted in gaseous form overhead from the reactor (1) through a distillation unit (2), the NH₃ is separated off by a vacuum unit (8), the product mixture (TSA, solvent, NH₄Cl, DSA) is condensed in a heat exchanger (7) and the product mixture (TSA, solvent L, NH₄Cl, DSA) is collected in a vessel (6) (see the FIGURE).

In the distillation, first NH₃ escapes through the heat exchanger (7) and the vacuum unit (8) into the off-gas. Subsequently, in the heat exchanger (7), for a short time the condensation temperature of DSA is established at the set pressure, for example at 0.5 bar a, about 12° C. Subsequently, in the heat exchanger (7) the condensation temperature of TSA at the set pressure is established, for example at 0.5 bar a, about 27° C.

The condensation temperature remains constant while pure TSA is distilled. The condensation temperature in the heat exchanger (7) starts to rise as soon as toluene is co-distilled. The fraction of toluene in the vapour continues to increase until pure toluene is distilled. At this time point, in the heat exchanger (7) the condensation temperature of the pure toluene at the set pressure is established, for example at 0.5 bar a, about 85° C. After a sufficient amount of pure toluene has been distilled, equivalent to ensuring that the bottom mixture remaining in the reactor is substantially free from TSA and DSA, the distillation is terminated by ending the heating of the reactor.

It is known to those skilled in the art that the time period for depressurizing and heating the reactor increases with the volume of the reactor, in order to start the distillation and obtain the first drops of TSA distillate. It may be advantageous to carry out the reaction in a reactor of small volume, preferably of 1 to 10 l, particularly preferably a volume of 5 l. Preferably, as soon as 2 hours after completion of the introduction of NH₃, or preferably as soon as 1 hour after completion of the further stirring at the temperature established and reaction conducted, the first drop of TSA distillate can be collected.

The time period between completion of the introduction of NH₃ and condensation of the first drop of TSA distillate or between completion of the further stirring at the temperature established in (a) and (b), and condensation of the first drop of TSA distillate depends on the time required for depressurizing the reactor and heating the reactor. The process according to the invention permits the distillation to be started directly subsequently to a one-hour further stirring at the temperature established in (a) and (b).

Overall, the process according to the present invention ensures, in particular under technical economic aspects, a high space-time yield for providing TSA.

The invention likewise relates to a plant or production unit for the process of the present invention, comprising (see the FIGURE):
a reactor (1) having feed lines for the components ammonia, at least MCS and (L) and
   an outlet for product mixture (TSA, L, NH₄Cl, DSA, NH₃), which opens into a
distillation unit (2) downstream of the reactor (1), a heat exchanger (7) having an attached vacuum pump (8) and a vessel (6) which is equipped with a line to
a filter unit (3) which has at least one solids outlet for NH₄Cl and a further line for transfer of the filtrate, which line opens into
a rectification column (4) which is equipped with an overhead outlet for DSA and a discharge facility for the mixture (TSA, L) from the bottom, which opens into
a rectification column (11) which is equipped with an overhead outlet for TSA and a discharge facility for the solvent (L) from the bottom, or which opens into
a batch rectification column into which the filtrate from the filter unit (3) is conducted,
   and a discharge facility in the reactor bottom for the bottom product mixture (L, NH₄Cl), which opens into
      a downstream filter unit (5) which has at least one solids outlet for NH₄Cl and a further line for transfer of the filtrate containing the solvent, which opens into
      a vessel (9).

Thus in another embodiment, the present invention provides a production unit to conduct the liquid phase process according the first embodiment, comprising:

a reactor, comprising:
a stirring unit;
a feed line for NH₃;
a feed line for a solution of at least MCS and a solvent;
an upper outlet which connects to a distillation unit; and
a bottom outlet; and downstream to the reactor;

a heat exchanger having an attached vacuum pump and a vessel;

a line from the vessel to a filter unit which comprises at least one solids outlet and

a further line for transfer of the filtrate which opens into either

a batch rectification column comprising an overhead outlet and a discharge facility from the bottom; or

a rectification system, comprising:

a first rectification column which is equipped with an overhead outlet, and a discharge facility from the bottom, which opens into

a second rectification column, which is equipped with an overhead outlet and a discharge facility from the bottom,

wherein the discharge facility from the bottom of the batch rectification column or the discharge facility from the bottom of the second rectification column is connected to a downstream filter unit which has at least one solids outlet and a further line for transfer of the filtrate which opens into a vessel.

From the continuously sequentially operated rectification columns, or from the batch rectification column, first DSA is removed overhead, and then TSA is removed overhead. In both cases the solvent can be recirculated. From vessel (9), 0 to 99% of the solvent may be recirculated. Non-recirculated solvent must be replaced by solvent (L). Plant components that are required for carrying out these options are known to those skilled in the art.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

The process will be illustrated below by reference to examples.

### Comparative Example 1

3400 ml of toluene and then 469 g of monochlorosilane were charged into a 5 l stirred autoclave purged in advance with inert gas and having cooling and heating modes and an attached distillation unit, comprising distillation column and condenser. 178 g of ammonia were added to the reaction solution in the course of a period of 7 hours 10 minutes. During the addition, the temperature was a constant 0° C. The pressure during the addition time was a constant 3 bar a.

After addition of the ammonia, the mixture was further stirred at 0° C. for 1 hour. Then, the reactor solution was adjusted to and held at −20° C. with continued further stirring overnight.

On the following day, a pressure of 0.5 bar a was set via a vacuum pump attached downstream of the distillation unit and the stirred autoclave was heated. By means of the distillation unit, TSA, DSA, fractions of toluene and traces of ammonium chloride were distilled off. Excess ammonia from the synthesis passed via the vacuum pump into the off-gas of the distillation. The cryostat of the distillate condenser was operated at −20° C. flow temperature. The first drop of TSA distillate was collected 17 hours 40 minutes after completion of the above described addition of ammonia to the reaction solution. The distillation was ended 1 hour 30 minutes after collection of the first drop of TSA distillate.

The distillate solution collected was filtered, was thereafter free from ammonium chloride and therefore clear. Then, firstly DSA (7 g) was separated off by rectification. The TSA (172 g) was then separated off from the toluene (384 g) by rectification.

After completion of the rectification operations, the rectification column used contained neither solids nor deposits. The cold trap downstream of the rectification column, after completion of the distillation, contained 1.5 g of substance which contained Si and N according to qualitative analysis.

The yield of the TSA separated off by distillation, based on the monochlorosilane used, was 68%. TSA was obtained at a purity of greater than 99.5% by weight.

The solution of toluene, ammonium chloride and small amounts of TSA, DSA and polysilazanes that was still situated in the stirred autoclave was drained off and filtered. The filtered toluene contained 6 g of TSA, 0.5 g of DSA, 3 g of polysilazanes and was free of ammonium chloride. The dried filtercake of ammonium chloride contained 3 g of silicon.

### Comparative Example 2

3400 ml of toluene and then 470 g of monochlorosilane were charged into a 5 l stirred autoclave purged in advance with inert gas and having cooling and heating modes and an attached distillation unit, comprising distillation column and condenser. 179 g of ammonia were added to the reaction solution in the course of a period of 7 hours 10 minutes. The temperature was a constant 0° C. during the addition. The pressure rose from 2.6 bar a to 2.8 bar a during the addition time.

After addition of the NH₃, the mixture was further stirred at 0° C. for 1 hour.

Then, a pressure of 0.5 bar a was set via a vacuum pump connected downstream of the distillation unit and the stirred autoclave was heated. By means of the distillation unit, TSA, DSA, fractions of toluene and traces of ammonium chloride were distilled off; excess ammonia from the synthesis passed into the off-gas of the distillation via the vacuum pump. The cryostat of the distillate condenser was operated at −20° C. flow temperature. The first drop of TSA distillate was collected 2 hours after completion of the above described addition of ammonia to the reaction solution. The distillation was completed 2 hours 10 minutes after collection of the first drop of TSA distillate.

The collected distillate solution was filtered, was thereafter free of ammonium chloride and therefore clear. Then, DSA (4 g) was firstly separated off by rectification. The TSA (173 g) was then separated off from the toluene (319 g) by rectification. After completion of the rectification operations, the rectification column used did not contain any solids or deposits. The cold trap downstream of the rectification column, after completion of the distillation, contained 5 g of substance which contained Si and N according to qualitative analysis.

The yield of the TSA separated off by distillation, based on the monochlorosilane used, was 68%. TSA of a purity of greater than 99.5% by weight was obtained.

The solution of toluene, ammonium chloride and small amounts of TSA, DSA and polysilazanes that were still situated in the stirred autoclave was drained off and filtered. The filtered toluene contained 9 g of TSA, 0.8 g of DSA, 3 g of polysilazanes and was free of ammonium chloride. The dried filtercake of ammonium chloride contained 3 g of silicon.

### Example 1

3400 ml of toluene and then 466 g of monochlorosilane were charged into a 5 l stirred autoclave purged in advance with inert gas and having cooling and heating modes and an attached distillation unit, comprising distillation column and condenser. 177 g of ammonia were added to the reaction solution in the course of a period of 7 hours 5 minutes. The temperature was a constant +10° C. during the addition. The pressure increased during the addition from 2.8 bar a to 3.1 bar a.

After the addition of ammonia, the mixture was stirred for a further 1 hour at +10° C. Then, the reactor solution was adjusted to and held at −20° C. under continued further stirring overnight.

On the following day, a pressure of 0.5 bar a was set via a vacuum pump attached downstream of the distillation unit and the stirred autoclave was heated. By means of the distillation unit, TSA, DSA, fractions of toluene and traces of ammonium chloride were distilled off. Excess ammonia from the synthesis passed via the vacuum pump into the off-gas of the distillation. The cryostat of the distillate condenser was operated at −20° C. flow temperature. The first drop of TSA distillate was collected 19 hours 25 minutes after completion of the above described addition of ammonia to the reaction solution. The distillation was ended 3 hours 50 minutes after collection of the first drop of TSA distillate. The process internal temperature in the distillate condenser rose during the distillation from −3 to +3° C.

At the process interior temperature in the distillate condenser of −3 rising to +3° C., TSA and the DSA formed in small amounts did not condense out quantitatively.

In order to collect completely the TSA and DSA that had not condensed out, downstream of the vacuum pump two wash bottles filled in total with 3370 g of 20% strength by weight sodium hydroxide solution were installed. TSA and DSA which passed into the wash bottles were hydrolysed. The quantitative analysis of the content of the wash bottles gave 15.2 g of silicon. Owing to the hydrolysis, the mass ratio between TSA and DSA could not be determined. If the 15.2 g of silicon had originated completely from TSA, this would have given an amount of TSA collected in the wash bottles of 19.4 g.

The collected distillate solution was filtered, was thereafter free from ammonium chloride and therefore clear. The solution was analysed quantitatively by means of gas chromatography and contained accordingly DSA (12.8 g), TSA (165.7 g) and toluene (145.3 g). The solution was further analysed quantitatively by ¹H NMR and contained accordingly DSA (14.9 g), TSA (165.5 g) and toluene (143.4 g).

The yield of TSA present in the distillate solution based on the monochlorosilane used was 66%.

The solution of toluene, ammonium chloride and small amounts of TSA, DSA and polysilazanes that is still situated in the stirred autoclave was drained off and filtered. The filtered toluene contained 4 g of TSA, 0.3 g of DSA, 4 g of polysilazanes and was free from ammonium chloride. The dried filtercake of ammonium chloride contained 3 g of silicon.

### NUMBERED REFERENCE LIST

[1] A. Stock, K. Somieski, Berichte der Deutschen Chemischen Gesellschaft 54 1921 pp. 740-758
[2] U. Wannagat, Fortschritte der Chemischen Forschung 9 (1) 1967 pp. 102-144
[3] A. MacDiarmid, Advances in inorganic chemistry and radiochemistry 3 1961 pp. 207-256,
[4] B. J. Aylett, M. J. Hakim, Inorganic Chemistry 5 (1) 1966 p. 167
[5] R. L. Wells, R. Schaeffer, Journal of the American Chemical Society 88 (1) 1966 pp. 37-42
[6] G. D. Miller, WO 2010/141551 A1
[7] C. J. Ritter, III, US 2013/0216463 A1
[8] A. V. Korolev, US 2013/0209343 A1
[9] C.-F. Hoppe, H. Rauleder, Ch. Götz, DE102011088814.4
[10] C.-F. Hoppe, H. Rauleder, Ch. Götz, G. Uehlenbruck, DE 102012214290.8
[11] C.-F. Hoppe, Ch. Götz, G. Uehlenbruck, H. Rauleder, DE 102013209802.2
[12] N. Y. Kovarsky, D. Lubomirsky, US 2011/0136347 A1

1. A liquid phase process for producing trisilylamine (TSA), comprising:
charging to a reactor of a production unit comprising the reactor, a distillation unit, a vacuum unit and a heat exchanger, a liquid solution comprising a solvent and monochlorosilane (MCS);
stirring the solution in the reactor;
setting the solution temperature to 10° C. or above and maintaining that temperature;
introducing NH₃ into the reactor in a stoichiometric excess relative to the MCS to conduct a reaction between the NH₃ and MCS to obtain a product mixture comprising TSA, disilylamine (DSA), solvent, NH₄Cl and NH₃;
depressurizing the reactor and setting the pressure to from 0.5 bar a to 0.8 bar a;
heating the reactor to obtain a gaseous product mixture comprising TSA, disilylamine (DSA), solvent, NH₄Cl and NH₃ and a bottom liquid mixture comprising solvent and NH₄Cl;
conducting the gaseous product mixture through the distillation unit;
separating the NH₃ from the gaseous product mixture via the vacuum unit;
condensing the gaseous product mixture from which the NH₃ is separated in a heat exchanger;
collecting the condensed product mixture as a solid-liquid mixture comprising TSA, solvent, solid NH₄Cl, and DSA in a vessel;
filtering the solid-liquid mixture in a filter unit to separate the solid NH₄Cl from a filtrate liquid comprising TSA, DSA and solvent;
conducting the filtrate liquid from the filter unit into a batch rectification column or to a rectification system comprising a first rectification column and a second rectification column;
wherein when the filtrate liquid is conducted to a batch rectification column, DSA is first separated off overhead and then TSA is separated off overhead; and
when the filtrate liquid is conducted to the rectification system,
the DSA is separated off overhead from the first rectification column to obtain a bottom mixture of TSA and solvent;
the liquid mixture of TSA and solvent is conducted into a second rectification column and the TSA is separated off overhead from the solvent; and
recirculating the solvent;
wherein
the solvent is inert with respect to MCS, ammonia (NH₃) and TSA, and
a boiling point of the solvent is higher than the boiling point of TSA, and
wherein the bottom liquid mixture comprising solvent and NH₄Cl from the reactor is conducted through a filter unit in which solid NH₄Cl is separated off,
and the solvent is collected in a vessel and optionally recirculated.

2. The process according to claim 1, wherein the temperature of the solution in the reactor is set to 10° C. to 30° C., and is maintained at the set temperature through the reaction with NH₃.

3. The process according to claim 1, wherein a volume ratio of MCS/solvent is from 10:1 to 3:1.

4. The process according to claim 1, wherein the solvent is toluene.

5. The process according to claim 1, wherein the stoichiometric
excess of NH₃ relative to MCS is from 0.5 to 5%.

6. The process according to claim 1, wherein the stirring of the solution in the reactor maintains the ammonium chloride NH₄Cl product in suspension and simultaneously ammonia (NH₃) introduced into the reactor (1) is finely distributed.

7. The process according to claim 1, wherein from 80 to 99% of the recovered solvent is recirculated, and non-recirculated solvent is replaced.

8. A production unit to conduct the liquid phase process according to claim 1, comprising:
a reactor, comprising:
a stirring unit;
a feed line for NH₃;
a feed line for a solution of at least MCS and a solvent;
an upper outlet which connects to a distillation unit; and
a bottom outlet; and downstream to the reactor;
a heat exchanger having an attached vacuum pump and a vessel;
a line from the vessel to a filter unit which comprises at least one solids outlet and
a further line for transfer of the filtrate which opens into either
a batch rectification column comprising an overhead outlet and a discharge facility from the bottom; or
a rectification system, comprising:
a first rectification column which is equipped with an overhead outlet, and a discharge facility from the bottom, which opens into
a second rectification column, which is equipped with an overhead outlet and a discharge facility from the bottom,
wherein the discharge facility from the bottom of the batch rectification column or the discharge facility from the bottom of the second rectification column is connected to a downstream filter unit which has at least one solids outlet and a further line for transfer of the filtrate which opens into a vessel.
